(19) United States
(12) Patent Application Publication
(10) Pub. No.: US 2018/0366963 A1
(43) Pub. Date: Dec. 20, 2018

(54) CHARGING SOCKET MOUNTING ASSEMBLY

(71) Applicant: Ming-Jen CHOU, Taipei City (TW)

(72) Inventor: Ming-Jen CHOU, Taipei City (TW)

(21) Appl. No.: 15/622,699

(22) Filed: Jun. 14, 2017

(51) Int. Cl. H02J 7/00; H01R 13/74; H01R 13/516; H01R 13/533

(52) U.S. Cl. CPC H02J 7/0045; H02J 7/0052; H01R 2201/26; H01R 13/516; H01R 13/533; H01R 13/748

(57) ABSTRACT

A charging socket mounting assembly includes a mounting box and a charging socket. The mounting box is made of a fireproof material and includes a box body and two mounting portions. The box body has a receiving space. The two mounting portions are connected to and extend outward from the box body. The charging socket includes a mounting plate and a socket body mounted in the mounting plate. The mounting plate includes a plurality of heat dissipation holes. The charging socket is mounted to the box body through the mounting plate, with the socket body received in the receiving space and the heat dissipation holes lying within the receiving space. Thus, the charging socket mounting assembly enhances safety of use.

### BACKGROUND OF THE INVENTION

### 1. Technical Field

The present invention relates to a charging socket mounting assembly and more particularly to one configured to ensure safety of use.

### 2. Description of Related Art

The steady rise of environmental awareness has driven car manufacturers home and abroad to make great efforts to develop electric cars, which, unlike their traditional counterparts, are powered by electricity rather than combustion of fuel. Electric cars, therefore, effectively avoid exhaust pollution typical of fuel-driven vehicles.

An electric car relies on a battery for the storage of electricity. As batteries require recharging when the stored electricity is used up, charging stations are installed on roadsides or at specific locations to facilitate recharging of electric cars. Alternatively, an electric car user may bring the car battery home for recharging if the battery is so designed. In the latter case, the user's house must be installed with a dedicated charging socket (in a wall of the house, for example) in order for the user to recharge the battery.

Conventionally, an electric car charging socket is mounted directly into a wall; that is to say, the charging socket is mounted in a hole in the wall, or embedded in the wall. As a result, the charging socket cannot dissipate heat efficiently and may burn or even cause fire, raising safety issues.

### BRIEF SUMMARY OF THE INVENTION

The present invention provides a charging socket mounting assembly that includes a mounting box and a charging socket. The mounting box is made of a fireproof material and includes a box body and two mounting portions. The box body has a receiving space, and the two mounting portions are connected to the box body and extend outward from the box body. The charging socket includes a socket body and a mounting plate. The socket body is mounted in the mounting plate. The mounting plate includes a plurality of heat dissipation holes. The charging socket is mounted to the box body through the mounting plate such that the socket body is received in the receiving space, with the heat dissipation holes lying within the receiving space.

The structural design described above ensures safety of use.

Preferably, the two mounting portions extend outward from two opposite sides of the box body respectively.

Preferably, one of the two mounting portions includes a vertical mounting slot, and the other mounting portion includes a horizontal mounting slot.

Preferably, the fireproof material is acrylonitrile butadiene styrene (ABS).

### BRIEF DESCRIPTION OF THE SEVERAL VIEWS OF THE DRAWINGS

FIG. 1 is an exploded perspective view of a preferred embodiment of the present invention;

FIG. 2 is an assembled perspective view of the preferred embodiment in FIG. 1; and

FIG. 3 shows a state of use of the preferred embodiment in FIG. 1.

### DETAILED DESCRIPTION OF THE INVENTION

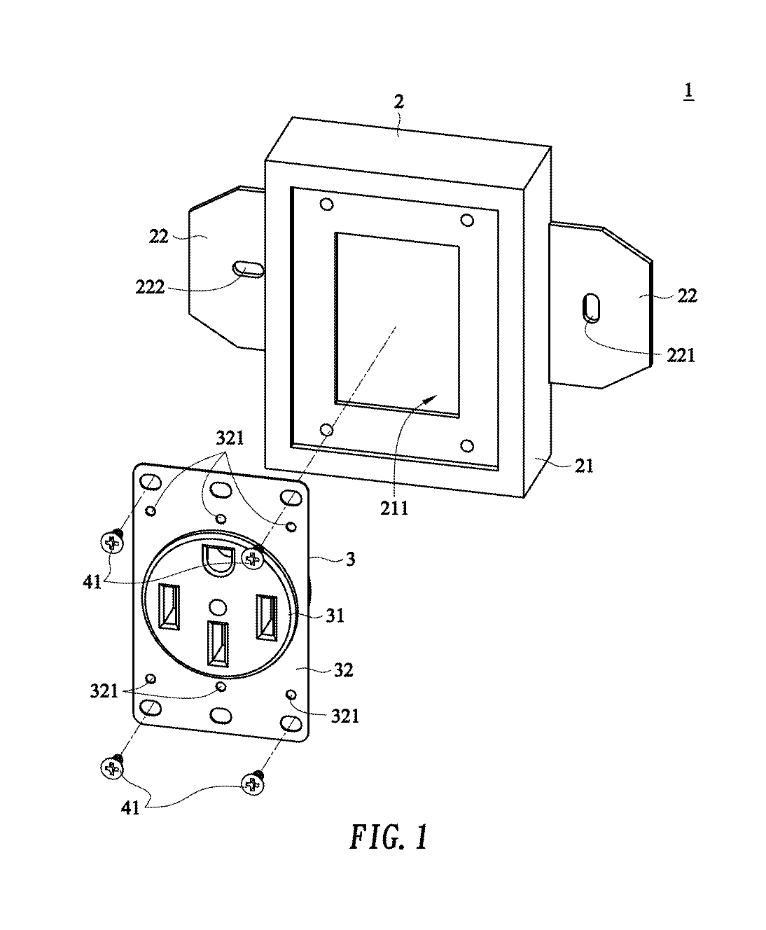

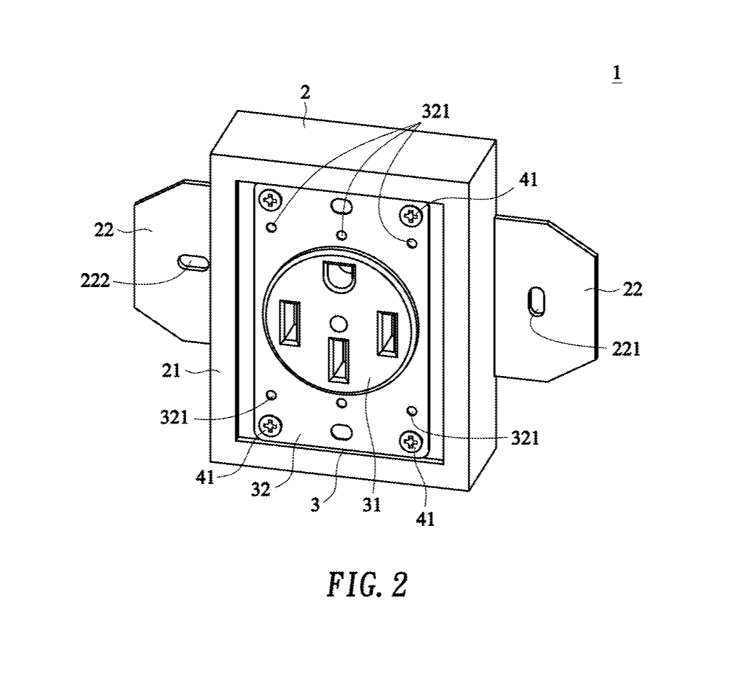

Referring to FIG. 1 and FIG. 2, which show a preferred embodiment of the present invention in an exploded perspective view and an assembled perspective view respectively, the charging socket mounting assembly 1 includes a mounting box 2 and a charging socket 3.

As shown in the drawings, the mounting box 2, which is made of a fireproof material such as acrylonitrile butadiene styrene (ABS), includes a box body 21 and two mounting portions 22. The box body 21 has a receiving space 211. The two mounting portions 22 are connected to the box body 21 and extend outward from the box body 21. In this embodiment, the two mounting portions 22 are a pair of lugs extending outward from the box body 21.

The charging socket 3 includes a socket body 31 and a mounting plate 32. The socket body 31 is mounted in the mounting plate 32, which includes a plurality of heat dissipation holes 321. The mounting plate 32 in this embodiment has an upper portion and a lower portion each provided with a plurality of heat dissipation holes 321.

As shown in the drawings, the charging socket 3 is mounted to the box body 21 via the mounting plate 32 (by means of screws 41 for example) such that the socket body 31 is received in the receiving space 211 of the box body 21, with the heat dissipation holes 321 lying within the receiving space 211 of the box body 21.

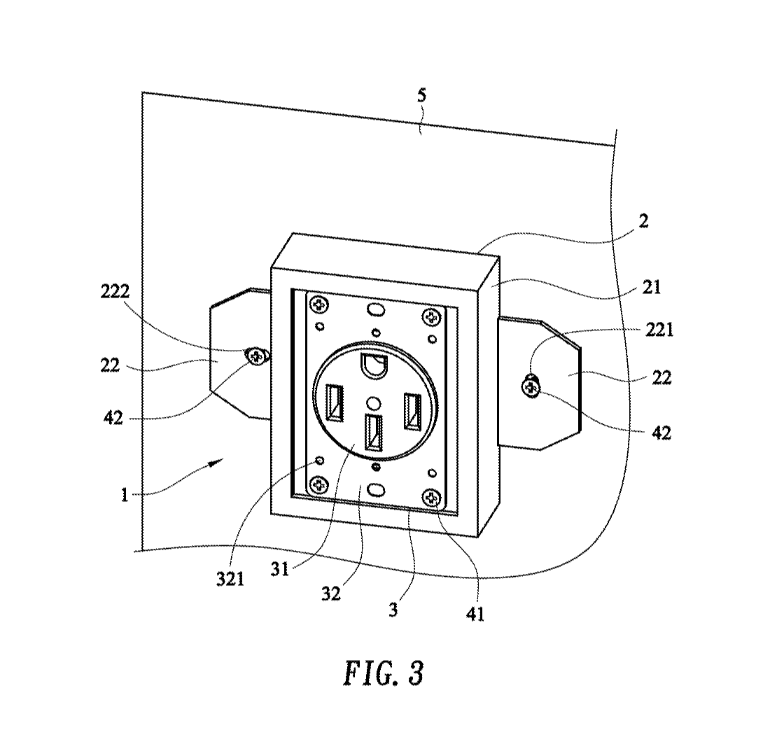

FIG. 3 shows a state of use of the preferred embodiment of the present invention.

Referring to FIG. 3 in conjunction with FIG. 1 and FIG. 2, the assembled charging socket mounting assembly 1 is mounted to a wall 5 by driving two screws 42 into the wall 5 through the two mounting portions 22 of the box body 21 respectively to lock the charging socket mounting assembly 1 threadedly on the wall 5.

Thanks to the heat dissipation holes 321 of the charging socket 3, and to the arrangement that the heat dissipation holes 321 of the charging socket 3 lie within the receiving space 211 of the box body 21 of the mounting box 2 once the charging socket 3 is mounted to the mounting box 2, the heat generated by the socket body 31 while the charging socket 3 is in use can dissipate through the heat dissipation holes 321, thereby eliminating the concern that the charging socket 3 may otherwise burn or even cause fire due to inefficient heat dissipation. The foregoing structural design, therefore, enhances safety of use.

In this embodiment, referring back to FIG. 1 and FIG. 2, the two mounting portions 22 of the mounting box 2 extend outward from two opposite sides of the box body 21 respectively. It is understood that the two mounting portions 22 may instead extend outward from two adjacent sides of the box body 21 respectively.

Moreover, one of the two mounting portions 22 of the mounting box 2 in this embodiment includes a vertical mounting slot 221 while the other mounting portion 22 includes a horizontal mounting slot 222. This structural design provides room for making adjustment to the screws 42 when the screws 42 are used to lock the charging socket mounting assembly 1 to the wall 5.

The embodiment described above is only a preferred one of the present invention and is not intended to be restrictive of the scope of the invention. All modifications, equivalent substitutions, and improvements that do not depart from the spirit or principle of the present invention should fall within the scope of the appended claims.

What is claimed is:

1. A charging socket mounting assembly, comprising:
a mounting box made of a fireproof material, wherein the mounting box comprises a box body and two mounting portions, the box body has a receiving space, and the two mounting portions are connected to and extend outward from the box body; and
a charging socket comprising a socket body and a mounting plate, wherein the socket body is mounted in the mounting plate, and the mounting plate comprises a plurality of heat dissipation holes;
wherein the charging socket is mounted to the box body through the mounting plate such that the socket body is received in the receiving space, with the heat dissipation holes lying within the receiving space.

2. The charging socket mounting assembly of claim 1, wherein the two mounting portions extend outward from two opposite sides of the box body respectively.

3. The charging socket mounting assembly of claim 2, wherein one of the two mounting portions comprises a vertical mounting slot, and the other mounting portion comprises a horizontal mounting slot.

4. The charging socket mounting assembly of claim 1, wherein the fireproof material is acrylonitrile butadiene styrene (ABS).
